(19) United States
(12) Patent Application Publication
(10) Pub. No.: US 2006/0077258 A1
(43) Pub. Date: Apr. 13, 2006

(54) System and method for tracking an object during video communication

(75) Inventors: Paul G. Allen, Mercer Island, WA (US); James A. Billmaier, Woodinville, WA (US); Robert E. Novak, Kirkland, WA (US)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Digeo, Inc., Kirkland, WA (US)

(21) Appl. No.: 11/281,087

(22) Filed: Nov. 17, 2005

Related U.S. Application Data
(63) Continuation of application No. 09/968,691, filed on Oct. 1, 2001.

(51) Int. Cl. H04N 5/225; H04N 7/14

(52) U.S. Cl. 348/169; 348/14.01

(57) ABSTRACT

An object is tracked with a camera that is sensitive to both visible and invisible light. An invisible light reflector attached to the object may reflect a target of invisible light, which is provided by an invisible light emitter. The camera processes the invisible light and moves the field of view of the camera so that the object is centered within the field of view. The camera may also zoom the field of view to a desired magnification level.

### CROSS-REFERENCE TO RELATED APPLICATIONS

This application is a continuation of U.S. Ser. No. 09/968,691, filed Oct. 1, 2001, for “System and Method for Tracking an Object During Video Communication,” which application is incorporated herein by reference in its entirety.

### FIELD OF THE INVENTION

The present invention relates generally to the field of video communication. More specifically, the present invention relates to a system and method for automatically tracking an object with a camera during video communication.

### DESCRIPTION OF RELATED BACKGROUND ART

Videoconferencing is rapidly becoming the communication method-of-choice for remote parties who wish to approximate face-to-face contact without the time and expense of travel. As bandwidth limitations cease to become a concern, a greater number of traditionally face-to-face events, such as business meetings, family discussions, and shopping, may be expected to take place through videoconferencing.

Unfortunately, videoconferencing has been limited in the past by a number of factors. One of the most appealing aspects of face-to-face communication is that people are able to see each other's facial gestures and expressions. Such expressions lend an additional dimension to a conversation; this dimension cannot be conveyed through a soley auditory medium. Hence, videoconferencing is typically carried out with the camera zoomed in to focus on the subject's head.

Such a focused view may be acceptable if neither person needs to move their head more than a few inches during the conversation. However, for lengthy conversations, it can be quite tiring to hold one's head in the same position continuously. Additionally, while a person can move about and perform tasks with their hands while talking on a telephone, such movement is severely restricted by the focused camera angles used in teleconferencing. Hence, it is difficult for a person to teleconference while performing other tasks. Additionally, conversation may be somewhat unnatural due to the necessity of maintaining the head and face in a single position.

Accordingly, what is needed is a system and method for tracking an object, such as a person, with a camera. Such a system should be usable for videoconferencing applications, and should not inhibit free motion of the person or object. Additionally, such a system and method should be operable with comparatively simple equipment and procedures.

### BRIEF DESCRIPTION OF THE DRAWINGS

Non-exhaustive embodiments of the invention are described with reference to the figures, in which:

FIG. 1 is an illustration of one embodiment of a tracking system according to the invention;

FIG. 2 is an illustration of a pre-tracking frame from the camera of FIG. 1;

FIG. 3 is an illustration of a centered frame from the camera of FIG. 1;

FIG. 4 is an illustration of a centered and zoomed frame from the camera of FIG. 1;

FIG. 5 is a schematic block diagram of one embodiment of a videoconferencing system in which the tracking system of FIG. 1 may be employed;

FIG. 6 is a schematic block diagram of the camera of FIG. 1;

FIG. 7 is a schematic block diagram of another embodiment of a camera suitable for tracking;

FIG. 8 is a schematic block diagram of one embodiment of a set top box usable in connection with the videoconferencing system of FIG. 5;

FIG. 9 is a logical block diagram depicting the operation of the tracking system of FIG. 1;

FIG. 10 is a flowchart of one embodiment of a tracking method according to the invention;

FIG. 11 is a flowchart depicting one embodiment of a centering method suitable for the tracking method of FIG. 10;

FIG. 12 is a flowchart depicting another embodiment of a centering method suitable for the tracking method of FIG. 10;

FIG. 13 is a flowchart depicting one embodiment of a zooming method suitable for the tracking method of FIG. 10; and

FIG. 14 is a flowchart depicting another embodiment of a zooming method suitable for the tracking method of FIG. 10.

### DETAILED DESCRIPTION OF THE PREFERRED EMBODIMENTS

The present invention solves the foregoing problems and disadvantages by providing a system and method for tracking objects with a camera during video communication. Of course, the described system and method are usable in a wide variety of other contexts, including security, manufacturing, law enforcement, and the like.

In one implementation, a reflector that reflects a form of invisible light, such as infrared light, is attached to an object to be tracked. Where the object is a person, such a reflector may be attached (by an adhesive or the like) to an article worn by the person, such a pair of glasses, a shirt collar, a tie clip, etc. The reflector may also be applied directly to the skin of the person. An invisible light emitter, such as an infrared illuminator, projects invisible light in the direction of the reflector. The invisible light is then reflected back to a camera that detects both visible and invisible light.

The camera provides a video signal with visible and invisible components. The invisible component is utilized by a tracking subsystem to center the field-of-view of the camera on the reflector. Centering may be accomplished with a mechanical camera by physically panning and tilting the camera until the reflector is in the center of the field-of-view. The camera may alternatively be a software steerable type, in which case centering is accomplished by cropping the camera image such that the reflector is in the center of the remaining portion.

The tracking component may mathematically determine the location of the reflector and then align the center of the field-of-view with the reflector. Alternatively, the tracking component may simply move the center of the field-of-view toward the reflector in stepwise fashion until alignment has been achieved.

A zooming subsystem may utilize the invisible and/or the visible component to “zoom,” or magnify, the field-of-view to reach a desired magnification level. As with tracking, such zooming may be accomplished mechanically or through software, using mathematical calculation and alignment or stepwise adjustment.

As an alternative embodiment, a portable emitter may be used in place of the reflector/emitter combination. Like the reflector, the portable emitter may be attached to the object to be tracked. The emitter may be powered by an integrated power source, such as a battery. Tracking and zooming may then be accomplished as described above.

As another alternative embodiment, the camera may simply receive the infrared signature of a human body, and may utilize the same to provide the invisible component of the video signal. Centering and zooming may then be accomplished with reference to the infrared signature, in much the same manner as described above. Additional steps may be performed to isolate the head and identify the person, if desired.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, user selections, network transactions, database queries, database structures, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The following discussion makes particular reference to two-way video communication. However, those skilled in the art recognize that video communication typically includes two-way audio communication. Thus, where video communication and corresponding components are specifically illustrated, audio communication and corresponding components may be implied.

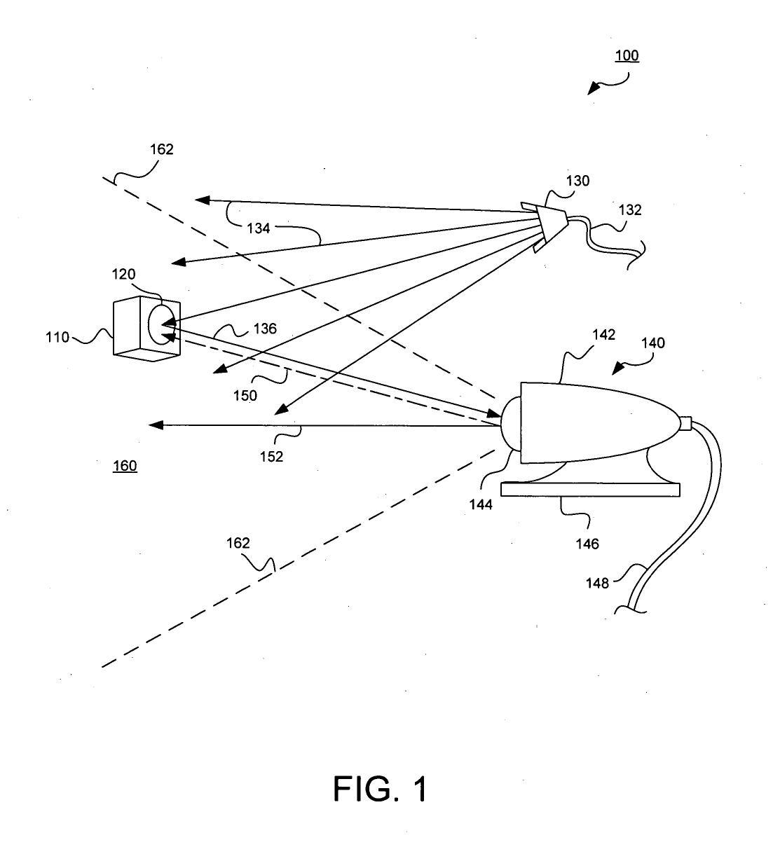

Referring to FIG. 1, one embodiment of a tracking system 100 according to the invention is shown. The object 110 may be inanimate, or may be a person, animal, or the like. The object 110 may have an invisible light reflector 120, or reflector 120, disposed on the object 110. As used herein, “invisible light” refers to electromagnetic energy with any frequency imperceptible to the human eye. Infrared light may advantageously be used due to the ease with which it can be generated and reflected; however, a wide variety of other electromagnetic spectra may also be utilized according to the invention, such as ultraviolet.

The reflector 120 may consist, for example, of a solid body with a reflective side coated with or formed of a substance that reflects invisible light. Such a surface may be covered by glass or plastic that protects the surface and/or serves as a barrier to the transmission of electromagnetic energy of undesired frequencies, such as those of the visible spectrum. The reflector 120 may have an adhesive surface facing opposite the reflective surface; the adhesive surface may be used to attach the reflector 120 to the object 110. Of course, the reflector 120 could also be attached to the object 110 using any other attachment method.

An invisible light emitter 130, or emitter 130, may be used to emit invisible light toward the object 110. The emitter 130 may be embodied, for example, as an infrared emitter, well known to those skilled in the art. As another example, the emitter 130 may take the form of a ultraviolet (UV) emitter.

The invisible light emitter 130 may receive electrical power through a power cord 132 or battery (not shown), and may project invisible light 134 over a broad angle so that the object 110 can move through a comparatively large space without the reflector 120 passing beyond the illuminated space.

Conventional light sources, including natural and artificial lighting, are also present and project visible light that is reflected by the object 110. Such light sources are not illustrated in FIG. 1 to avoid obscuring aspects of the invention.

A portion 136 of the invisible light 134 may be reflected by the reflector 120 to reach a camera 140. In one embodiment, the camera 140 is sensitive to both visible light and invisible light of the frequency reflected by the reflector 120. The camera 140 may have a housing 142 that contains and protects the internal components of the camera 140, a lens 144 through which the portion 136 of the invisible light 134 is able to enter the housing 142, a base 146 that supports the housing 142, and an output cord 148 through which a video signal is provided by the camera 140. Of course, the camera 140 may be configured in other ways without departing from the spirit of the invention. For instance, the camera 140 may lack a separate housing and may be integrated with another device, such as a set top box (STB) for an interactive television system.

The video signal produced by the camera 140 may simply include a static image, or may include real-time video motion suitable for videoconferencing. The video signal may also include audio information, and may have a visible component derived from visible light received by the camera 140 as well as an invisible component derived from the portion 136 of the invisible light 134.

The object 110 may have a vector 150 with respect to the camera 140. The vector 150 is depicted as arrow pointing from the camera 140 to the object 110, with a length equal to the distance between the object 110 and the camera 140. A center vector 152 points directly outward from the camera 140, into the center of a field-of-view 160 of the camera 140.

The field-of-view 160 of the camera 140 is simply the volume of space that is “visible” to the camera 140, or the volume that will be visible in an output image from the camera 140. The field-of-view 160 may be generally conical or pyramidal in shape. Thus, boundaries of the field-of-view 160 are indicated by dashed lines 162 that form a generally triangular cross section. The field-of-view 160 may be variable in size if the camera 140 has a “zoom,” or magnification feature.

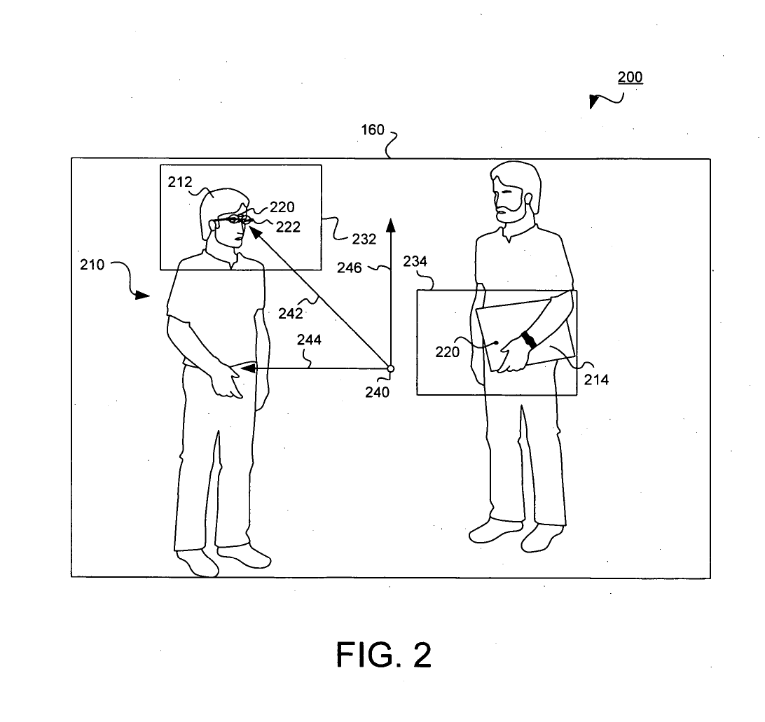

As described in greater detail below, the present invention provides a system and method by which the center vector 152 can be automatically aligned with the object vector 150. Such alignment may take place in real time, such that the field-of-view 160 of the camera 140 follows the object 110 as the object 110 moves. Optionally, the camera 140 may automatically zoom, or magnify, the object 110 within the field-of-view 160. The operation of these processes, and their effect on the visible output of the camera 140, will be shown and described in greater detail in connection with FIGS. 2 through 4.

Referring to FIG. 2, an exemplary pre-tracking view 200 of visible output, i.e., a display of the visible component of the video signal, is shown. Since the pre-tracking view 200 is taken from the point of view of the camera 140, a rectangular cross-sectional view of the field-of-view 160 is shown. The field-of-view 160 is thus assumed to be rectangular-pyramidal in shape; if the field-of-view 160 were conical, the view depicted in FIG. 2 would be circular.

In FIG. 2, a person 210 takes the place of the generalized object 110 of FIG. 1. The camera 140 may be configured to track the person 210, or if desired, a head 212 of the person, while the person 210 moves. The camera 140 may also be used to track an inanimate object such as a folder 214. Reflectors 220 may be attached to the person 210 and/or the folder 214 in order to facilitate tracking.

In the case of the person 210, the reflectors 220 may be affixed to an article worn by the person 210, such as a pair of glasses, a piece of jewelry, a tie clip, or the like. Like the reflector 110 of FIG. 1, the reflector 210 may have a reflective side and a non-reflective side that can be attached through the use of a clip, clamp, adhesive, magnet, pin, or the like. A reflector 220 may then be affixed to an object such as a pair of glasses 222 or, in the alternative, directly to the person 210. A reflector 220 may be easily affixed to the folder 214 in much the same fashion.

Indeed, if desired, an invisible light reflector need not be a solid object, but may be a paint, makeup, or other coating applicable directly to an object or to the skin of the person 210. Such a coating need simply be formulated to reflect the proper frequency of invisible light. The coating may even be substantially transparent to visible light.

The person 210, or the head 212 of the person 210, may have a desired view 232, or an optimal alignment and magnification level for video communications. Similarly, the folder 214 may have a desired view 234. The reflectors 220 may be positioned at the respective centers of the desired views 232, 234, so that the field-of-view 160 may be aligned with such a desired view.

Each of the reflectors 220 provides a “target,” or a bright spot within the invisible component of the video signal from the camera 140. Thus, each reflector 220 enables the camera 140 to determine the direction in which the associated object vector 150 points. Once the object vector 150 is determined, the tracking system 100 may proceed to align the object vector 150 with the center vector 152.

More specifically, a center 240 of the field-of-view 160 is an end view of the center vector 152 depicted in FIG. 1. In the view of FIG. 2, the reflector 220 disposed on the person 210 is an end view of the object vector 150. Thus, “tracking,” refers to motion of the field-of-view 160 until the center 240 is superimposed on the reflector 220. Consequently, the center 240 is to be moved along a displacement 242 between the center 240 and the reflector 220.

Such movement may be broken down into two separate dimensions: a pan displacement 244 and a tilt displacement 246. The pan displacement 244 represents the amount “panning,” or horizontal camera rotation, that would be required to align the center 240 with the reflector 220. The tilt displacement 246 represents the amount of “tilting,” or vertical camera rotation, that would be required to align the center 240 with the reflector 220.

Panning and tilting may be carried out by physically moving the camera 140. More specifically, physical motion of the camera 140 may be carried out through the use of a camera alignment subsystem (not shown) that employs mechanical devices, such as rotary stepper motors. Two such motors may be used: one that pans the camera 140, and one that tilts the camera 140.

In the alternative, panning and tilting may be carried out by leaving the camera 140 stationary and modifying the video signal. For example, panning and tilting may be performed in conjunction with zooming by cropping the video signal. The video signal is obtained by capturing a second field-of-view (not shown) that covers a comparatively broad area. For example, a wide-angle, or “fish-eye” lens could be used for the lens 144 of the camera 140 to provide a wide second field-of-view. The first field-of-view 160 is then obtained by cropping the second field-of-view and correcting any distortion caused by the wide angle of the lens 144.

Panning and tilting without moving the camera 140 may be referred to as “software steerable” panning and tilting, although the subsystems that carry out the tracking may exist in software, hardware, firmware, or any combination thereof. Software steerable panning and tilting will be described in greater detail subsequently.

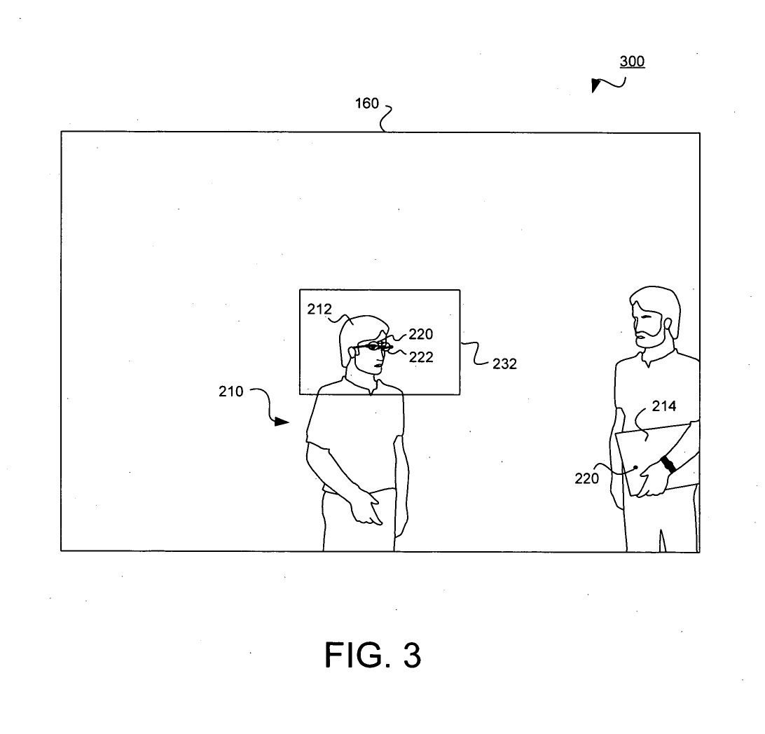

Referring to FIG. 3, a centered view 300 of visible output from the camera 140 is shown. The field-of-view 160 has been panned and tilted through mechanical or software steerable processing such that the center 240 is aligned with the reflector 220 on the person 210; consequently, tracking has been performed. The center 240 is not shown in FIG. 3 for clarity. The desired view 232 of the head 212 of the person 210 is now centered within the field-of-view 160. However, the field-of-view 160 has not been resized to match the desired view 232; hence, no zooming has occurred.

“Centering,” as used herein, may not require precise positioning of the head within the center 240 of the field-of-view 160. In the view of FIG. 3, the head 212 is positioned slightly leftward of the center 240 of the field-of-view 160. This is due to the fact that the person 210 is not looking directly at the camera 140; hence, the reflector 220 is disposed toward the right side of the head 212, from the perspective of the camera 140. Consequently, the reflector 220 is disposed at the center 240 of the field-of-view 160, but the head 212 is slightly offset. Such offsetting is unlikely to seriously impede videoconferencing unless the field-of-view 160 is excessively narrow.

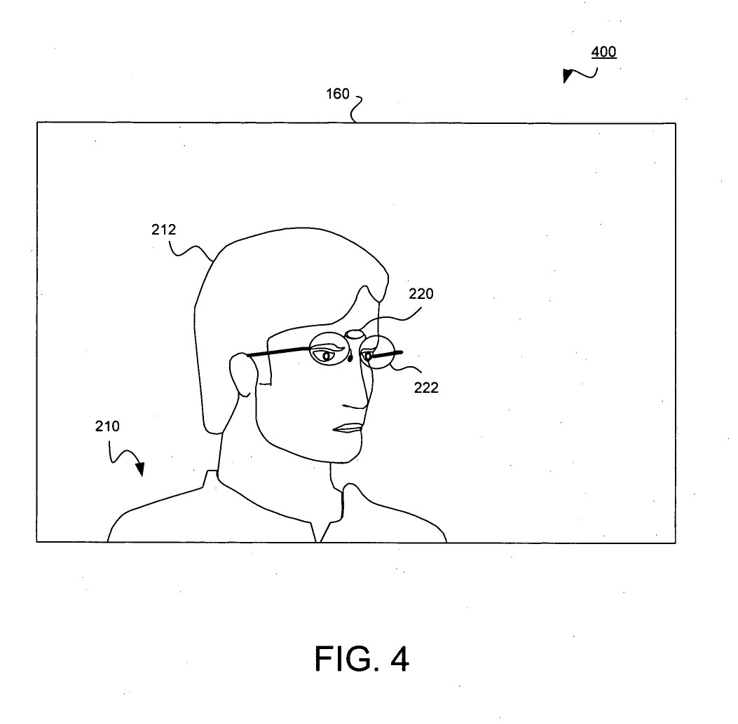

Referring to FIG. 4, a zoomed and centered view 400 of visible output from the camera 140 is shown. The reflector 220 is still centered within the field-of-view 160, and the field-of-view 160 has been collapsed to match the desired view 232, in which the head 212 appears large enough to read facial expressions during verbal communication with the person 210. Consequently, both tracking (centering) and zooming have been performed.

As with tracking, zooming may be performed mechanically, or “optically.” Optical zooming typically entails moving the lens or lenses of the camera to change the size of the field-of-view 160. Additionally, lenses may be mechanically added, removed, or replaced to provide additional zooming capability.

In the alternative, zooming may also be performed through software. For example, an image may be cropped and scaled to effectively zoom in on the remaining portion. Such zooming may be referred to as software, or “digital” zooming.

The tracking and zooming functions have been illustrated as separate steps for clarity; however, tracking need not be carried out prior to zooming. Indeed, tracking and zooming may occur simultaneously in real-time as the person 210 moves within the field-of-view 160. The head 212 of the person 210 may thus be maintained continuously centered at the proper magnification level during video communication. A similar process may be carried out with the folder 214, or with any other object with a reflector 220 attached. The following discussion assumes that the head 212 of the person 210 is the object to be tracked.

The tracking system 100, or multiple such tracking systems, may be used in a wide variety of applications. As mentioned previously, videoconferencing is one application in which such tracking systems may find particular application.

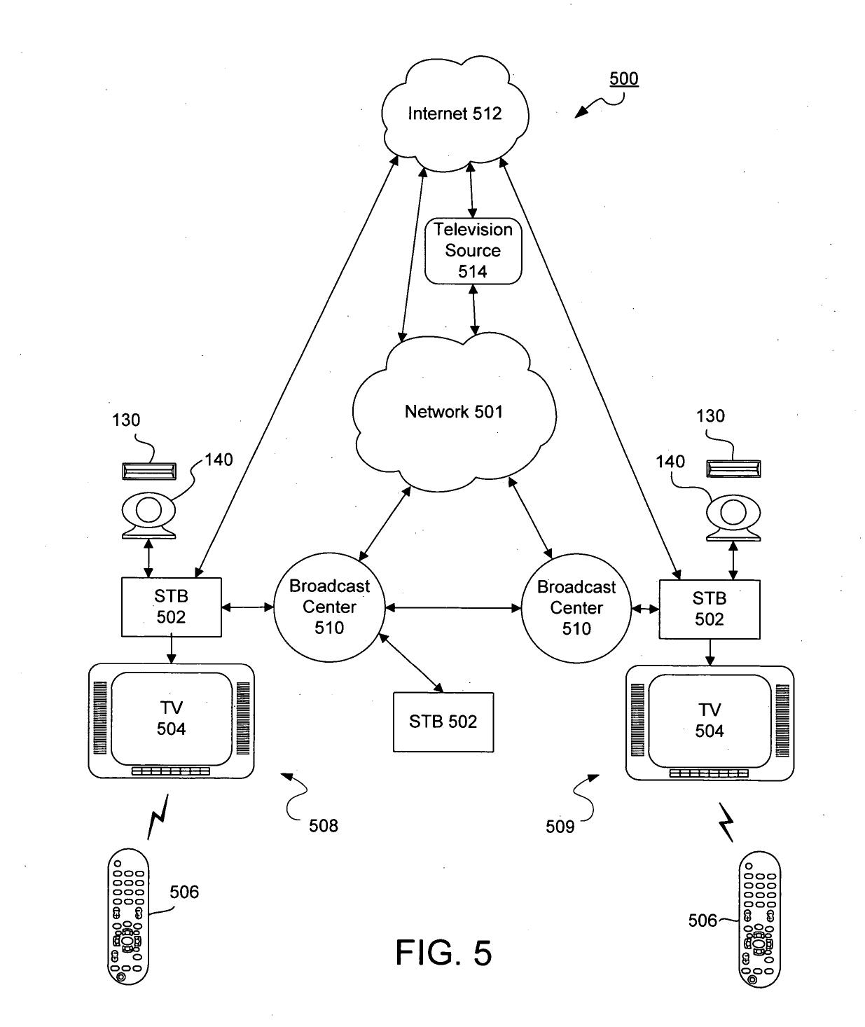

Referring to FIG. 5, one embodiment of a videoconferencing system 500 that may incorporate one or more tracking systems 100 is shown. In one implementation, the videoconferencing system 500 relies on a communication subsystem 501, or network 501, for communication. The network 501 may take the form of a cable network, direct satellite broadcast (DBS) network, or other communications network.

The videoconferencing system 500 may include a plurality of set top boxes (STBs) 502 located, for instance, at customer homes or offices. Generally, an STB 502 is a consumer electronics device that serves as a gateway between a customer's television 504 and the network 501. In alternative embodiments, an STB 502 may be embodied more generally as a personal computer (PC), an advanced television 504 with STB functionality, or other customer premises equipment (CPE).

An STB 502 receives encoded television signals and other information from the network 501 and decodes the same for display on the television 504 or other display device, such as a computer monitor, flat panel display, or the like. As its name implies, an STB 502 is typically located on top of, or in close proximity to, the television 504.

Each STB 502 may be distinguished from other network components by a unique identifier, number, code, or address, examples of which include an Internet Protocol (IP) address (e.g., an IPv6 address), a Media Access Control (MAC) address, or the like. Thus, video streams and other information may be transmitted from the network 501 to a specific STB 502 by specifying the corresponding address, after which the network 501 routes the transmission to its destination using conventional techniques.

A remote control 506 is provided, in one configuration, for convenient remote operation of the STB 502 and the television 504. The remote control 506 may use infrared (IR), radio frequency (RF), or other wireless technologies to transmit control signals to the STB 502 and the television 504. Other remote control devices are also contemplated, such as a wired or wireless mouse or keyboard (not shown).

For purposes of the following description, one STB 502, TV 504, remote control 506, camera 140, and emitter 130 combination is designated a local terminal 508, and another such combination is designated a remote terminal 509. Each of the terminals 508, 509 is designed to provide videoconferencing capability, i.e., video signal capture, transmission, reception, and display.

The components of the terminals 508, 509 may be as shown, or may be different, as will be appreciated by those of skill in the art. For example, the TVs 504 may be replaced by computer monitors, webpads, PDA's, computer screens, or the like. The remote controls 506 may enhance the convenience of the terminals 508, 509, but are not necessary for their operation. As mentioned previously, the STB 502 may be configured in a variety of different ways. The camera 140 and the emitter 130 may also be reconfigured or omitted, as will be described subsequently.

Each STB 502 may be coupled to the network 501 via a broadcast center 510. In the context of a cable network, a broadcast center 510 may be embodied as a “head-end”, which is generally a centrally-located facility within a community where television programming is received from a local cable TV satellite downlink or other source and packaged together for transmission to customer homes. In one configuration, a head-end also functions as a Central Office (CO) in the telecommunication industry, routing video streams and other data to and from the various STBs 502 serviced thereby.

A broadcast center 510 may also be embodied as a satellite broadcast center within a direct broadcast satellite (DBS) system. A DBS system may utilize a small 18-inch satellite dish, which is an antenna for receiving a satellite broadcast signal. Each STB 502 may be integrated with a digital integrated receiver/decoder (IRD), which separates each channel, and decompresses and translates the digital signal from the satellite dish to be displayed by the television 504.

Programming for a DBS system may be distributed, for example, by multiple high-power satellites in geosynchronous orbit, each with multiple transponders. Compression (e.g., MPEG) may be used to increase the amount of programming that can be transmitted in the available bandwidth.

The broadcast centers 510 may be used to gather programming content, ensure its digital quality, and uplink the signal to the satellites. Programming may be received by the broadcast centers 510 from content providers (CNN®, ESPN®, HBO®, TBS®, etc.) via satellite, fiber optic cable and/or special digital tape. Satellite-delivered programming is typically immediately digitized, encrypted and uplinked to the orbiting satellites. The satellites retransmit the signal back down to every earth-station, e.g., every compatible DBS system receiver dish at customers' homes and businesses.

Some broadcast programs may be recorded on digital videotape in the broadcast center 510 to be broadcast later. Before any recorded programs are viewed by customers, technicians may use post-production equipment to view and analyze each tape to ensure audio and video quality. Tapes may then be loaded into a robotic tape handling systems, and playback may be triggered by a computerized signal sent from a broadcast automation system. Back-up videotape playback equipment may ensure uninterrupted transmission at all times.

Regardless of the nature of the network 501, the broadcast centers 510 may be coupled directly to one another or through the network 501. In alternative embodiments, broadcast centers 510 may be connected via a separate network, one particular example of which is the Internet 512. The Internet 512 is a “network of networks” and is well known to those skilled in the art. Communication over the Internet 512 is accomplished using standard protocols, such as TCP/IP (Transmission Control Protocol/Internet Protocol) and the like. If desired, each of the STBs 502 may also be connected directly to the Internet 512 by a dial-up connection, broadband connection, or the like.

A broadcast center 510 may receive television programming for distribution to the STBs 502 from one or more television programming sources 514 coupled to the network 501. Preferably, television programs are distributed in an encoded format, such as MPEG (Moving Picture Experts Group). Various MPEG standards are known, such as MPEG-2, MPEG-4, MPEG-7, and the like. Thus, the term “MPEG,” as used herein, contemplates all MPEG standards. Moreover, other video encoding/compression standards exist other than MPEG, such as JPEG, JPEG-LS, H.261, and H.263. Accordingly, the invention should not be construed as being limited only to MPEG.

Broadcast centers 510 may be used to enable audio and video communications between STBs 502. Transmission between broadcast centers 510 may occur (i) via a direct peer-to-peer connection between broadcast centers 510, (ii) upstream from a first broadcast center 510 to the network 501 and then downstream to a second broadcast center 510, or (iii) via the Internet 512. For instance, a first STB 502 may send a video transmission upstream to a first broadcast center 510, then to a second broadcast center 510, and finally downstream to a second STB 502.

Each of a number of the STBs 502 may have a camera 140 connected to the STB 502 and an emitter 130 positioned in close proximity to the camera 140 to permit videoconferencing between users of the network 501. More specifically, each camera 140 may be used to provide a video signal of a user. Each video signal may be transmitted over the network 501 and displayed on the TV 504 of a different user. Thus, one-way or multiple-way communication may be carried out over the videoconferencing system 500, using the network 501. Of course, the videoconferencing system 500 illustrated in FIG. 5 is merely exemplary, and other types of devices and networks may be used within the scope of the invention.

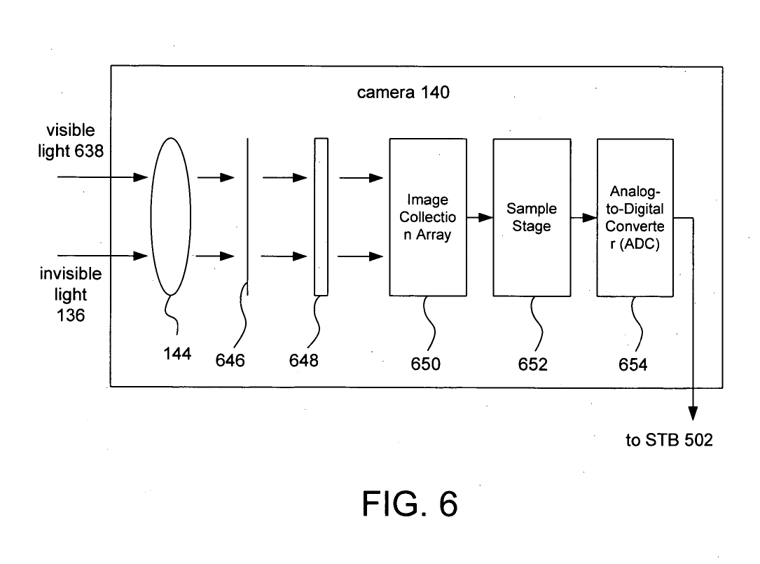

Referring to FIG. 6, a block diagram shows one embodiment of a camera 140 according to the invention. The camera 140 may receive both visible and invisible light through the lens 144, and may process both types of light with a single set of hardware to provide the video signal. In addition to the lens 144, the camera 140 may include a shutter 646, a filter 648, an image collection array 650, a sample stage 652, and an analog-to-digital converter (ADC) 654.

As mentioned previously, if software steerable panning and tilting are to be utilized, the lens 144 may be a wide angle lens that has an angular field of, for example, 140 degrees. Using a wide angle lens allows the camera 140 to capture a larger image area than a conventional camera. The shutter 646 may open and close at a predetermined rate to allow the visible and invisible light into the interior of the camera 140 and onto the filter 648.

The filter 648 may allow the image collection array 650 to accurately capture different colors. The filter 648 may include a static filter such as a Bayer filter, or may utilize a dynamic filter such as a spinning disk filter. Alternatively, the filter 648 may be replaced with a beam splifter or other color differentiation device. As yet another alternative, the camera 140 may be made to operate without any filter or other color differentiation device.

The image collection array 650 may included charge coupled device (CCD) sensors, complementary metal oxide semiconductor (CMOS) sensors, or other sensors that convert electromagnetic energy into readable image signals. If software steerable panning and tilting are to be used, the size of the image collection array 650 may be comparatively large such as, for example, 1024×768, 1200×768, or 2000×1000. Such a large size permits the image collection array 650 to capture a large image to form the video signal from the comparatively large second field-of-view. The large image can then be cropped and/or distortion-corrected to provide the properly oriented first field-of-view 160 without producing an overly grainy or diminutive image.

The sample stage 652 may read the image data from the image collection array 650 when the shutter 646 is closed. The ADC 654 may then convert the image data from analog to digital form to provide the video signal ultimately output by the camera 140. The video signal may then be transmitted to the STB 502, for example, via the output cord 148 depicted in FIG. 1 for processing and/or transmission. In the alternative, the video signal may be processed entirely by components of the camera 140 and transmitted from the camera 140 directly to the network 501, the Internet 512, or other digital communication devices.

Those of skill in the art will recognize that a number of known components may also be used in conjunction with the camera 140. For purposes of explaining the functionality of the invention, such known components that may be included in the camera 140 have been omitted from the description and drawings.

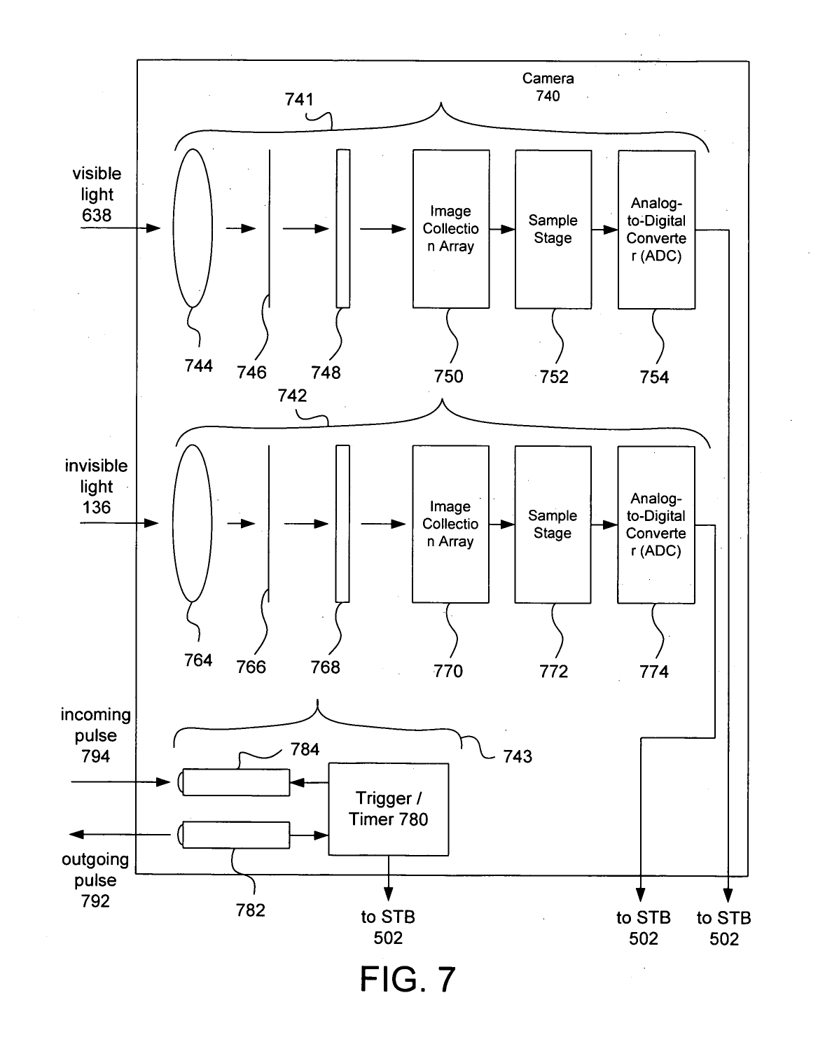

Referring to FIG. 7, another embodiment of a camera 740 according to the invention is depicted. Rather than processing visible and invisible light simultaneously with a single set of hardware, the camera 740 may have a visible light assembly 741 that processes visible light and an invisible light assembly 742 that processes invisible light. The camera 740 may also have a range finding assembly 743 that determines the length of the object vector 150, which is the distance between the camera 140 and the person 210.

The visible light assembly 741 may have a lens 744, a shutter 746, a filter 748, an image collection array 750, a sample stage 752, and an analog-to-digital converter (ADC) 754. The various components of the visible light assembly 741 may be configured in a manner similar to the camera 140 of FIG. 6, except that the visible light assembly 741 need not process invisible light. If desired, the lens 744 may be made to block out a comparatively wide range of invisible light. Similarly, the image collection array 750 may record only visible light.

By the same token, the invisible light assembly 742 may have a lens 764, a shutter 766, a filter 768, an image collection array 770, a sample stage 772, and an analog-to-digital converter (ADC) 774 similar to those of the visible light assembly 741, but configured to receive invisible rather than visible light. Consequently, if desired, the lens 764 may be tinted, coated, or otherwise configured to block out all but the frequencies of light reflected by the reflector 220. Similarly, the image collection array 770 may record only the frequencies of light reflected by the reflector.

Ultimately, the visible light assembly 741 may produce the visible component of the video signal, and the invisible light assembly 742 may produce the invisible component of the video signal. The visible and invisible components may then be delivered separately to the STB 502, as shown in FIG. 7, or merged within the camera 140 prior to delivery to the STB 502. The visible and invisible light assemblies 741, 742 need not be entirely separate as shown, but may utilize some common elements. For example, a single lens may be used to receive both visible and invisible light, while separate image collection arrays are used for visible and invisible light. Alternatively, a single image collection array may be used, but may be coupled to separate sample stages. Many similar variations may be made. As used herein, the term “camera” may refer to either the camera 140, the camera 740, or different variations thereof.

The range finding assembly 743 may have a trigger/timer 780 designed to initiate range finding and relay the results of range finding to the STB 502. The trigger/timer 780 may be coupled to a transmitter 782 and a receiver 784. When triggered by the trigger/timer 780, the transmitter 782 sends an outgoing pulse 792, such as an infrared or sonic pulse, toward the head 212 of the person 210. The outgoing pulse 792 bounces off the head 212 and returns in the form of an incoming pulse 794 that can be received by the receiver 784.

The trigger/timer 780 may measure the time differential between transmission of the outgoing pulse 792 and receipt of the incoming pulse 794; the distance between the head 212 and the camera 740 is proportional to the time differential. The raw time differential or a calculated distance measurement may be transmitted by the trigger/timer 780 to the STB 502. Determining the distance between the head 212 and the camera 740 may be helpful in zooming the first field-of-view 160 to the proper magnification level to obtain the desired view 232.

Numerous other camera embodiments may be used according to the invention. Indeed, a more traditional analog camera may be used to read visible and invisible light. Such an analog camera may provide an analog video signal that can be subsequently digitized, or may include analog-to-digital conversion circuitry like the ADC 754 and the ADC 774. For the sake of brevity, the following discussion assumes the use of the camera 140.

If desired, the video signal may be processed outside the camera 140. If software steerable panning and tilting is utilized, such processing may include cropping and distortion correction of the video signal. If the camera 140 is used as part of a videoconferencing system like the videoconferencing system 500, the STB 502 may be a logical place in which to carry out such processing.

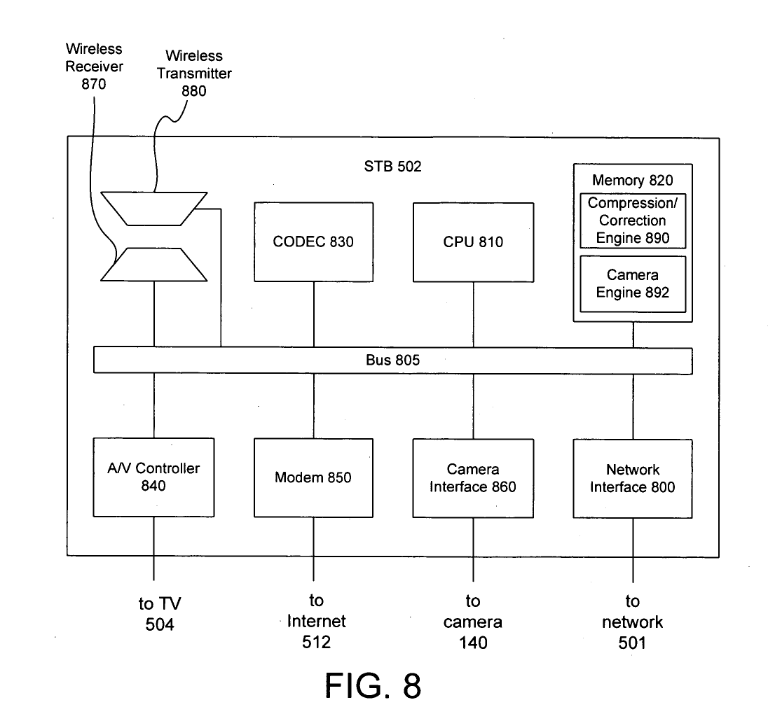

Referring to FIG. 8, there is shown a block diagram of physical components of an STB 502 according to an embodiment of the invention. The STB 502 may include a network interface 800 through which television signals, video signals, and other data may be received from the network 501 via one of the broadcast centers 510. The network interface 800 may include conventional tuning circuitry for receiving, demodulating, and demultiplexing MPEG-encoded television signals, e.g., digital cable or satellite TV signals. In certain embodiments, the network interface 800 may include analog tuning circuitry for tuning to analog television signals, e.g., analog cable TV signals.

The network interface 800 may also include conventional modem circuitry for sending or receiving data. For example, the network interface 800 may conform to the DOCSIS (Data Over Cable Service Interface Specification) or DAVIC (Digital Audio-Visual Council) cable modem standards. Of course, the network interface and tuning functions could be performed by separate components within the scope of the invention.

In one configuration, one or more frequency bands (for example, from 5 to 30 MHz) may be reserved for upstream transmission. Digital modulation (for example, quadrature amplitude modulation or vestigial sideband modulation) may be used to send digital signals in the upstream transmission. Of course, upstream transmission may be accomplished differently for different networks 501. Alternative ways to accomplish upstream transmission include using a back channel transmission, which is typically sent via an analog telephone line, ISDN, DSL, or other techniques.

A bus 805 may couple the network interface 800 to a processor 810, or CPU 810, as well as other components of the STB 502. The CPU 810 controls the operation of the STB 502, including the other components thereof. The CPU 810 may be embodied as a microprocessor, a microcontroller, a digital signal processor (DSP) or other device known in the art. For instance, the CPU 810 may be embodied as an Intel® x86 processor. The CPU 810 may perform logical and arithmetic operations based on program code stored within a memory 820.

The memory 820 may take the form of random access memory (RAM), for storing temporary data and/or read-only memory (ROM) for storing more permanent data such as fixed code and configuration information. The memory 820 may also include a mass storage device such as a hard disk drive (HDD) designed for high volume, nonvolatile data storage.

Such a mass storage device may be configured to store encoded television broadcasts and retrieve the same at a later time for display. In one embodiment, such a mass storage device may be used as a personal video recorder (PVR), enabling scheduled recording of television programs, pausing (buffering) live video, etc.

A mass storage device may also be used in various embodiments to store viewer preferences, parental lock settings, electronic program guide (EPG) data, passwords, e-mail messages, and the like. In one implementation, the memory 820 stores an operating system (OS) for the STB 502, such as Windows CE® or Linux®; such operating systems may be stored within ROM or a mass storage device.

The STB 502 also preferably includes a codec (encoder/decoder) 830, which serves to encode audio/video signals into a network-compatible data stream for transmission over the network 501. The codec 830 also serves to decode a network-compatible data stream received from the network 501. The codec 830 may be implemented in hardware, firmware, and/or software. Moreover, the codec 830 may use various algorithms, such as MPEG or Voice over IP (VoIP), for encoding and decoding.

In one embodiment, an audio/video (A/V) controller 840 is provided for converting digital audio/video signals into analog signals for playback/display on the television 504. The A/V controller 840 may be implemented using one or more physical devices, such as separate graphics and sound controllers. The A/V controller 840 may include graphics hardware for performing bit-block transfers (bit-blits) and other graphical operations for displaying a graphical user interface (GUI) on the television 504.

The STB 502 may also include a modem 850 by which the STB 502 is connected directly to the Internet 512. The modem 850 may be a dial-up modem connected to a standard telephone line, or may be a broadband connection such as cable, DSL, ISDN, or a wireless Internet service. The modem 850 may be used to send and receive various types of information, conduct videoconferencing without the network 501, or the like.

A camera interface 860 may coupled to receive the video signal from the camera 140. The camera interface 860 may include, for example, a universal serial bus (USB) port, a parallel port, an infrared (IR) receiver, an IEEE 1394 (“firewire”) port, or other suitable device for receiving data from the camera 140. The camera interface 860 may also include decoding and/or decompression circuitry that modifies the format of the video signal.

Additionally, the STB 502 may include a wireless receiver 870 for receiving control signals sent by the remote control 506 and a wireless transmitter 880 for transmitting signals, such as responses to user commands, to the remote control 506. The wireless receiver 870 and the wireless transmitter 880 may utilize infrared signals, radio signals, or any other electromagnetic emission.

A compression/correction engine 890 and a camera engine 892 may be stored in the memory 820. The compression/correction engine 890 may perform compression and distortion compensation on the video signal received from the camera 140. Such compensation may permit a wide-angle, highly distorted “fish-eye” image to be shown in an undistorted form. The camera engine 892 may accept and process user commands relating to the pan, tilt, and/or zoom functions of the camera 140. A user may, for example, select the object to be tracked, select the zoom level, or other parameters related to the operation of the tracking system 100.

Of course, FIG. 8 illustrates only one possible configuration of an STB 502. Those skilled in the art will recognize that various other architectures and components may be provided within the scope of the invention. In addition, various standard components are not illustrated in order to avoid obscuring aspects of the invention.

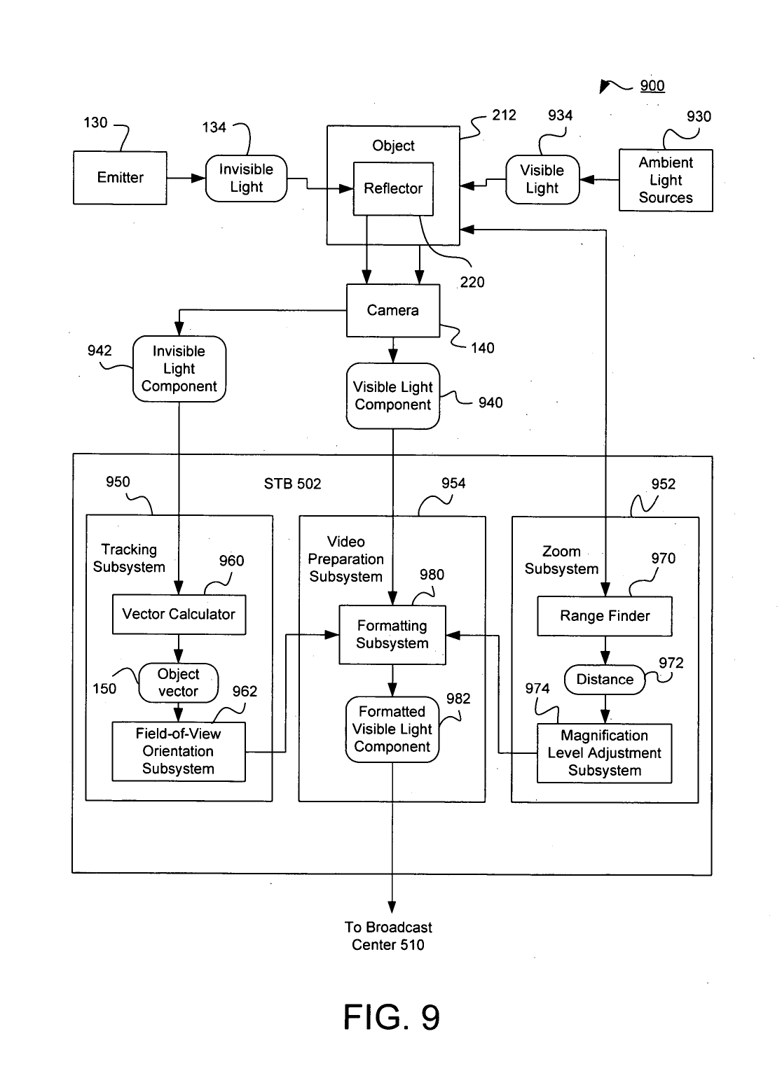

Referring to FIG. 9, a logical block diagram 900 shows one possible manner in which light and signals may interact in the tracking system 100 of FIG. 1. The illustrated steps/components may be implemented in hardware, software, or firmware, using any of the components of FIG. 8, alone or in combination. While various components are illustrated as being disposed within a STB 502, those skilled in the art will recognize that similar components may be included within the camera, itself.

As described previously, the emitter 130 emits invisible light 134 that is reflected by the reflector 220. Ambient light sources 930 have not been shown in FIG. 1 for clarity; the ambient light sources 930 may include the sun, incandescent lights, fluorescent lights, or any other source that produces visible light 934. The visible light 934 reflects off of the object 212 (e.g., head), and possibly the reflector 220.

Both visible and invisible light are reflected to the camera 140, which produces a video signal with a visible light component 940 and an invisible light component 942. The visible light component 940 and the invisible light component 942 are conveyed to the STB 502. If a camera such as the camera 740 is used, the camera 740 may also transmit the distance between the camera 740 and the object 212, which is determined by the range finding assembly 743, to the STB 502.

The invisible light component 942 may be processed by a tracking subsystem 950 that utilizes the invisible light component 942 to orient the field-of-view 160. For example, the tracking subsystem 950 may move the field-of-view 160 from that shown in FIG. 2 to that shown in FIG. 3.

The tracking subsystem 950 may have a vector calculator 960 that determines the direction in which the object vector 150 points. Such a determination may be relatively easily made, for example, by determining which pixels of the digitized invisible light component 942 contain the target reflected by the reflector 220.

The vector calculator 960 may, for example, measure luminance values or the like to determine which pixels correspond to the reflector. The target reflected by the reflector 220 can be expected to be the brightest portion of the invisible component 942. The frequency and intensity of the invisible light emitted by the emitter 130 may be selected to ensure that the brightest invisible light received by the camera 140 is that reflected by the reflector 220.

Alternatively, the field-of-view orientation subsystem 962 may determine the location of the reflector 220 through software such as an objectivication algorithm that analyzes motion of the reflector 220 with respect to surrounding objects. Such an objectivication algorithm may separate the field-of-view 160 into “objects,” or portions that appear to move together, and are therefore assumed to be part of a common solid body. Thus, the field-of-view orientation subsystem 962 may resolve the reflector 220 into such an object, and perform tracking based on that object. As one example, an algorithm such as MPEG-4 may be used.

In any case, the vector calculator 960 may provide the object vector 150 to a field-of-view orientation subsystem 962. The field-of-view orientation subsystem 962 may then center the camera 140 on the object 212 (e.g., aligning the center vector 152 with the object vector 150.

Thus, the field-of-view orientation subsystem 962 may perform the centering operation shown in FIG. 2 to align the center 240 of the field-of-view 160 with the target reflected by the reflector 220. The field-of-view orientation subsystem 962 may, for example, determine the magnitudes of the pan displacement 244 and the tilt displacement 246, and perform the operations necessary to pan and tilt the field-of-view 160 by the appropriate distances. As mentioned previously, panning and tilting may be performed mechanically, or through software.

The magnitudes of the pan and tilt displacements 244, 246 do not depend on the distance between the object 212 and the camera 140. Consequently, the tracking subsystem 950 need not determine how far the object 212 is from the camera 140 to carry out tracking. A two-dimensional object vector 150, i.e., a vector with an unspecified length, is sufficient for tracking.

As an alternative to the analytical tracking method described above, the tracking subsystem 950 may perform tracking through trial and error. For example, the tracking subsystem 950 need not determine the object vector 150, but may simply determine which direction the field-of-view 160 must move to bring the object 212 nearer the center 240. In other words, the tracking subsystem 950 need not determine the magnitudes of the pan and tilt displacements 244, 246, but may simply determine their directions, i.e., up or down and left or right. The field-of-view 160 may then be repeatedly panned and/or tilted by a preset or dynamically changing incremental displacement until the object 212 is centered within the field-of-view 160.

The STB 502 may also have a zoom subsystem 952 that widens or narrows the field-of-view 160 to the appropriate degree. The zoom subsystem 952 may, for example, modify the field-of-view 160 from that shown in FIG. 3 to that shown in FIG. 4.

Since the camera 140 shown in FIG. 9 does not have range finding hardware, the zoom subsystem 952 may have a range finder 970 that determines a distance 972 between the camera 140, or the STB 502, and the object 212. The range finder 970 may be configured in a manner similar to the range finding assembly 743 of the camera 740, with a trigger/timer, transmitter, and receiver (not shown) that cooperate to send and receive an infrared or sonic pulse and determine the distance based on the lag between outgoing and incoming pulses.

If a camera with a range finding assembly 743 or other range finding hardware, such as the camera 740, were to be used in place of the camera 140, the STB 502 may not require a range finder 970. The tracking system 100 may alternatively determine the distance between the camera 140 and the object 212 through software such as an objectivication algorithm that determines the size of the head 212 within the field-of-view 160 based on analyzing motion of the head 212 with respect to surrounding objects. Such an objectivication algorithm may, for example, be MPEG 4 or any other known objectivication algorithm.

The distance 972 obtained by the range finder 970 may be conveyed to a magnification level adjustment subsystem 974, which may use the distance 972 to zoom the field-of-view 160 to an appropriate magnification level. The magnification level may be fixed, intelligently determined by the magnification level subsystem 974, or selected by the user.

In any case, the magnification level may vary in real-time such that the object 212 always appears to be the same size within the field-of-view 160. Such zooming may be performed, for example, through the use of a simple linear mathematical relationship between the distance 972 and the size of the field-of-view 160. More specifically, the ratio of object size to field-of-view size may be kept constant.

For example, when the head 212 of the person 210 moves away from the camera 140, the magnification level adjustment subsystem 974 may narrow the field-of-view 160, or “zoom in” so that the ratio of sizes between the head 212 and the field-of-view 160 remains the same. The field-of-view size refers to the size of the rectangular area processed by the camera, such as the views of FIG. 2, FIG. 3, and FIG. 4. If the head 212 moves toward the camera 140, the field-of-view 160 may be broadened, or “zoomed out,” to maintain the same ratio. Thus, the facial features of the person 210 will still be easily visible when the person 210 moves toward or away from the camera 140.

In the alternative to the analytical zooming method described above, zooming may also be performed through trial and error. For example, the magnification level adjustment subsystem 974 may simply determine whether the field-of-view 160 is too large or too small. The field-of-view 160 may then be repeatedly broadened or narrowed by a preset increment until the field-of-view 160 is zoomed to the proper magnification level, i.e., until the ratio between the size of the object 212 and the size of the field-of-view 160 is as desired.

The visible light component 940 of the video signal from the camera 140 may be conveyed to a video preparation subsystem 954 of the STB 502. The video preparation subsystem 954 may have a formatting subsystem 980 that transforms the visible light component 940 into a formatted visible component 982 suitable for transmission, for example, to the broadcast center 510 to which the STB 502 is connected. The formatted visible component 982 may also be displayed on the TV 504 connected to the STB 502, for example, if the person 210 wishes to verify that the camera 140 is tracking his or her head 212 properly.

The field-of-view orientation subsystem 962 and the magnification level adjustment subsystem 974 determine the orientation and zoom level of the formatted visible light component 982. In the case of mechanical panning, tilting, and zooming, the camera 140 may be controlled by the field-of-view orientation subsystem 962 and the magnification level adjustment subsystem 974. Thus, the visible light component 940 would already be properly oriented and zoomed.

However, the logical block diagram 900 of FIG. 9 assumes that panning, tilting, and zooming are managed through software. Thus, the field-of-view orientation subsystem 962 and the magnification level adjustment subsystem 974 may interact directly with the formatting subsystem 980 to modify the visible light component 940. More specifically, the formatting subsystem 980 may receive instructions from the field-of-view orientation subsystem 962 and the magnification level adjustment subsystem 974 to determine how to crop the visible light component 940. After cropping, the formatted visible light component 982 provides a centered and zoomed image.

The formatted visible component 982 may be conveyed over the network 501 to the remote terminal 509, which may take the form of another STB 502, TV 504, and/or camera 140 combination, as shown in FIG. 5. A user at the remote terminal 509 may view the formatted visible component 982, and may transmit a visible component of a second video signal captured by the remote terminal 509 back to the local terminal 508 for viewing on the TV 504 of the local terminal 508. Thus, the users of the local and remote terminals 508, 509 may carry out two-way videoconferencing through the use of the communication subsystem 501, or the network 501.

If desired, software steerable technology may be used to provide a second formatted visible light component (not shown) of a different object. For example, the visible light component 940 of the video signal from the camera 140 may be cropped a first time to provide the desired view 232 of the head 212 of the person 210, as shown in FIG. 4. The desired view 232 may be formatted to form the formatted visible component 982. The visible light component 940 may be cropped a second time to provide the desired view 234 of the folder 214. The desired view 234 of the folder 214 may be formatted to form the second formatted visible light component 982.

In such a fashion, a plurality of additional cropped subsets of the visible light component 940 may be provided. Each cropped subset may be sent to a different remote terminal 509, for example, if multiple parties wished to see different parts of the view of FIG. 2. Thus, multiple objects can be tracked and conveyed over the network 501 with a single camera 140. Of course, one cropped subset could be displayed on the TV 504 of the local terminal 508 or recorded for future playback.

The tracking system 100 also may perform other functions aside from videoconferencing. For example, the tracking system 100 may be used to locate articles for a user. A reflector 220 may be attached to a set of car keys, the remote control 506, or the like, so that a user can activate the tracking system 100 to track the car keys or the remote control 506.

An object may, alternatively, be equipped with an active emitter that generates invisible light that can be received by the camera 140. The remote control 506 may, for example, emit invisible light, either autonomously or in response to a user command, to trigger tracking and display of the current whereabouts of the remote control 506 on the TV 504.

The reflector 220 may also be disposed on a child to be watched. A user may then use the tracking system 100 to determine the current location of the child, and display the child's activities on the TV 504. Thus, the tracking system 100 can be used in a wide variety of situations besides traditional videoconferencing.

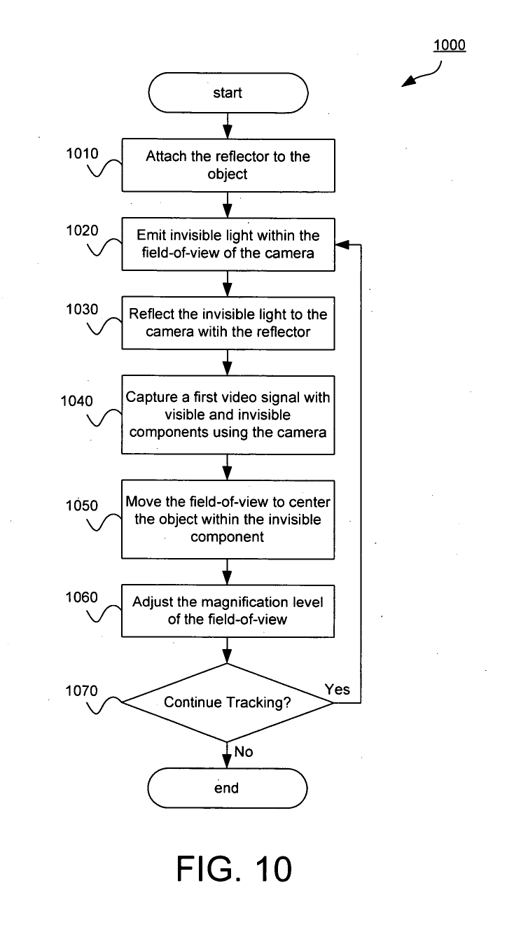

Referring to FIG. 10, one possible embodiment of a tracking method 1000 that may be carried out in conjunction with the tracking system 100 is depicted. The reflector 220 may first be attached 1010 to the object 212. Such attachment may be accomplished through any known attachment mechanism, including clamps, clips, pins, adhesives, or the like.

Invisible light 134 may then be emitted 1020 such that the invisible light 134 enters the field-of-view 160 and impinges against the reflector 220. The reflector 220 reflects 1030 the portion 136 of the invisible light 134 to the camera 140. The camera 140 captures 1040 a first video signal that includes the visible component 940 derived from visible light received by the camera 140 and the invisible component 942 derived from the portion 136 of invisible light received by the camera 140.

The field-of-view 160 is then moved 1050 or oriented, for example, by the tracking subsystem 950 to center the object 212 within the invisible component 942. The size of the field-of-view 160 may be adjusted by the zoom subsystem 952 to obtain the desired zoom factor.

Since the head 212 of the person 210 can be expected to move about within the field-of-view 160, tracking and zooming may be carried out continuously until centering and zooming are no longer desired. If tracking is to continue 1070, the steps from emitting 1020 invisible light through adjusting 1060 the magnification level may be repeated continuously. If there is no further need for tracking and zooming, i.e., if videoconferencing has been terminated or the user has otherwise selected to discontinue zooming and tracking, the tracking method 1000 may terminate.

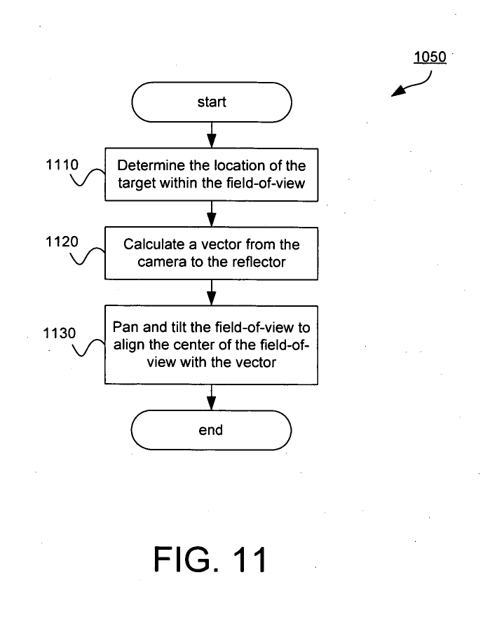

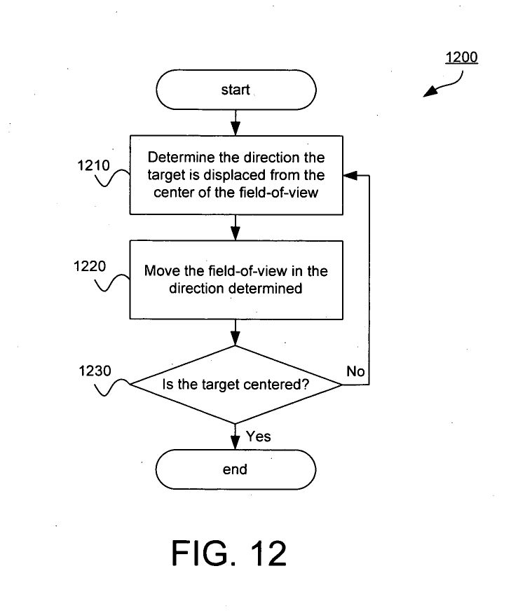

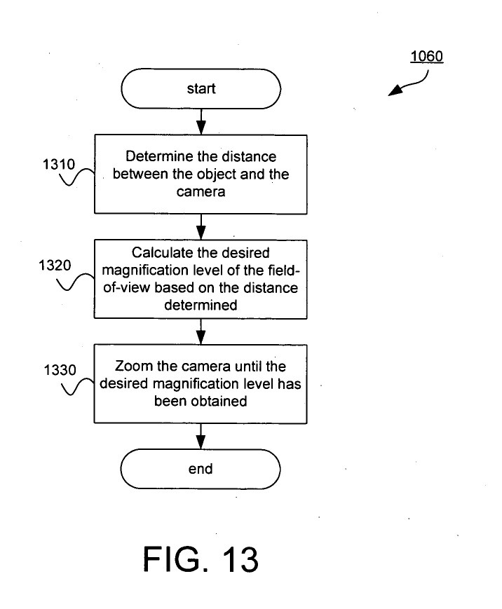

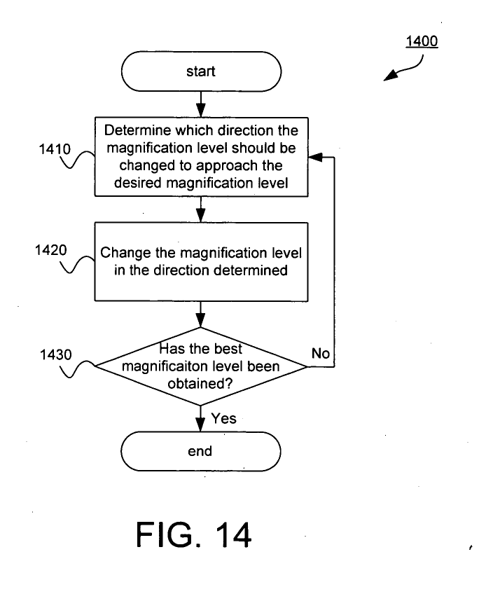

For each of the steps of moving 1050 the field-of-view 160 and adjusting 1060 the magnification level of the field-of-view 160, the tracking system 100 may perform multiple tasks. Such tasks will be outlined in greater detail in connection with FIGS. 11 and 12, which provide two embodiments for moving 1050 the field-of-view 160, and FIGS. 13 and 14, which provide two embodiments for adjusting 1060 the magnification level of the field-of-view 160.

Referring to FIG. 11, moving 1050 the field-of-view 160 may include determining 1110 the location of the target reflected by the reflector 220 within the field-of-view 160. The object vector 150 may then be calculated 1120, for example, by the vector calculator 960. The field-of-view 160 may then be panned and tilted 1130 to align the center vector 152 of the field-of-view 160 with the object vector 150.

Referring to FIG. 12, an alternative embodiment of a centering method 1200 is depicted, which may operate in place of the method 1050 described in FIG. 11. The method 1050 of FIG. 11 may be referred to as analytical, while the method 1200 utilizes trial and error.

The centering method 1200 may commence with determining 1210 the direction the target, or the object 212, is displaced from the center 240 of the field-of-view 160. The field-of-view 160 may then be moved 1220, or panned and tilted, so that the center 240 is brought closer to the target provided by the reflector 220, or the object 212. If the target is not yet centered, the steps of determining 1210 the direction to the target and moving 1220 the field-of-view 160 may be repeated until the target is centered, or within a threshold distance of the center 240 of the field-of-view 160.

Referring to FIG. 13, adjusting 1060 the magnification level of the field-of-view 160 may commence with determining 1310 the distance 972 between the object 212 and the camera 140. Determining 1310 the distance may be carried out by the range finder 970, or by a range finding assembly 743 if a camera such as the camera 740 is used. The desired magnification level of the field-of-view 160 may then be calculated 1320 using the distance 972, for example, by maintaining a constant ratio of the distance 972 to the size of the field-of-view 160. The camera may then be zoomed 1330 until the desired magnification level has been achieved.

Referring to FIG. 14, an alternative embodiment of a zooming method 1400 is depicted, which may operate in place of the method 1060 described in FIG. 13. Like the method 1050 of FIG. 11, the method 1060 of FIG. 13 may be referred to as analytical, while the method 1400 utilizes trial and error, like the method 1200.

The method 1400 may first determine 1410 whether the magnification level is too large or too small, i.e., whether the object 212 appears too large or too small in the field-of-view 160. The magnification level may then be changed 1420 incrementally in the direction required to approach the desired magnification level. If the best (i.e., desired) magnification level has not been obtained 1430, the method 1400 may iteratively determine 1410 in which direction such a change is necessary and change 1420 the magnification level in the necessary direction, until the desired magnification level is obtained.

The methods presented in FIGS. 10 through 14 may be utilized with a number of different embodiments besides those explicitly described in the foregoing examples. Furthermore, those of skill in the art will recognize that other methods may be used to carry out tracking and zooming according to the invention.

The tracking system 100 may be modified in a number of ways. For example, the emitter 130 and reflector 120, or reflectors 220, may be replaced by portable emitters that actively generate invisible light. Such emitters may, for example, take the form of a specialized bulb, lens, or bulb/lens combination connected to a portable power source such as a battery.

Such a portable emitter may then be used in much the same manner as the reflectors 220, i.e., disposed on an object or an article worn by the person 210. The portable emitter may therefore have an attachment mechanism such as a clip, clamp, adhesive, magnet, pin, or the like. The discussion of FIGS. 2 through 9 applies to the portable emitter, with which tracking may be accomplished in substantially the same manner as previously described.

As yet another alternative, the invisible light produced by a normal human body may be used in place of the reflector 220 and emitter 130. The human body radiates electromagnetic energy within the infrared spectrum; consequently, the camera 140 may receive invisible light from the person 210 without the aid of any emitter or reflector.

Tracking may be performed by determining the location of a “hot spot,” or area of comparatively intense infrared radiation, such as the head 212. The forehead and eyes tend to form such a hot spot; hence, tracking based on infrared intensity may provide easy centering on the eyes of the person. Other areas of relatively higher infrared intensity (e.g., the chest) are typically covered by clothing. Hence, for applications such as videoconferencing, tracking based on the intensity of infrared radiation from the human body provides a technique for centering the head 212 within the field-of-view 160.

In the alternative, tracking may be performed by locating an area that emits a comparatively specific infrared frequency. If desired, the camera 140 and/or STB 502 may be calibrated to the individuals with which they will be used. Thus, the camera 140 will be able to perform tracking despite ordinary variations in body temperature from one person to the next.

An objectivication algorithm may also be used in conjunction with tracking based on the infrared radiation of the human body. More specifically, objectivication may be utilized to resolve the invisible component 942 into one or more people based on the shapes and/or motion of the infrared radiation received. Thus, the locations of people within the field-of-view 160 can be determined without the use of a reflector or emitter.

Those of skill in the art will recognize that tracking may also be accomplished in a number of ways within the scope of the invention. For example, low power microwave radiation may be emitted by an emitter similar to the emitter 130 of FIG. 1. Invisible light within the microwave frequency band may be somewhat more readily distinguished from ambient light, such as electromagnetic emissions from the sun, artificial lights, or other warm objects. The light produced by such ambient sources may be mostly infrared or visible. Hence, the use of microwave radiation may enable more effective tracking by reducing ambient interference. Microwave radiation may be read and processed in substantially the same manner as described above.

Furthermore, regardless of the frequency of light detected, additional processing may be carried out to distinguish between objects to be tracked and surrounding objects. For example, through a method such as Doppler detection, differentials between emitted wavelengths and received wavelengths may be used to determine whether an object is moving toward or away from the camera. Objects in motion, such as people, may therefore reflect light with a frequency shifted somewhat from the frequency of the emitted light. Conversely, stationary objects may be assumed to reflect or emit a consistent frequency. Thus, a moving object may be distinguished from other changes in electromagnetic emission, such as changing sunlight patterns.

Based on the foregoing, the present invention offers a number of advantages not available in conventional approaches. During videoconferencing, a camera keeps a person or object continuously within its field-of-view. Moreover, the field-of-view is continuously zoomed to maintain the relative size of the person or object being tracked. Thus, a person need not remain in a fixed position during videoconferencing, but may freely move about a room, while still being visible to remote parties.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

1. A videoconferencing system comprising:
an invisible light source disposed on a first participant to a video conference;
a camera, sensitive to both visible and invisible light, that captures a first video signal depicting the first participant, the first video signal having visible and invisible components;
a tracking subsystem that utilizes the invisible component to orient a first field-of-view of the camera to center the invisible light source within the first field-of-view;
a communication subsystem to transmit the visible component of the first video signal to a second participant to the video conference and to receive a second video signal depicting a second participant; and
a display subsystem to display the second video signal to the first participant.

2. The videoconferencing system of claim 1, wherein the invisible light source comprises an invisible light emitter.

3. The videoconferencing system of claim 1, further comprising an invisible light emitter, wherein the invisible light source comprises an invisible light reflector.

4. The videoconferencing system of claim 3, wherein the invisible light emitter is disposed at a fixed location independent of the location of the first participant and the camera.

5. The system of claim 1, wherein the tracking subsystem comprises a vector calculator that calculates a vector from the camera to the invisible light source based on the location of the invisible light source within the invisible component of the first video signal.

6. The system of claim 5, wherein the tracking subsystem comprises a camera alignment subsystem that physically aligns the camera along the calculated vector.

7. The system of claim 1, wherein the first field-of-view is a cropped subset of a second field-of-view of the camera, and wherein the tracking subsystem moves the first field-of-view to a location within the second field-of-view in which the invisible light source is centered.

8. The system of claim 1, further comprising:
a range finder that calculates a distance between the first participant and the camera.

9. The system of claim 8, further comprising:
a magnification level subsystem for adjusting a magnification level of the camera based on the distance between the first participant and the camera.

10. The method of claim 1, wherein the camera includes separate image collection arrays for capturing the visible and invisible components.

11. A method for tracking a participant during two-way video communication comprising:
providing for capturing a first video signal depicting a first participant to a video conference wearing an invisible light source, the first video signal having both visible and invisible components;
providing for orienting a first field-of-view of a camera to center the invisible light source within the first field-of-view;
providing for transmitting the visible component of the first video signal to a second participant to the video conference;
providing for receiving a second video signal depicting a second participant; and
providing for displaying the second video signal to the first participant.

12. The method of claim 11, wherein the invisible light source comprises an invisible light emitter.

13. The method of claim 11, wherein the invisible light source comprises an invisible light reflector to reflect invisible light from an invisible light emitter.

14. The method of claim 13, wherein the invisible light emitter is disposed at a fixed location independent of the location of the first participant and the camera.

15. The method of claim 11, providing for calculating a vector from the camera to the invisible light source based on a location of the invisible light source within the invisible component of the first video signal.

16. The method of claim 15, wherein providing for tracking comprises providing for physically aligning the camera along the calculated vector.

17. The method of claim 11, wherein the first field-of-view is a cropped subset of a second field-of-view of the camera, and wherein providing for tracking comprises providing for moving the first field-of-view to a location within the second field-of-view in which the invisible light source is centered.

18. The method of claim 11, further comprising:
providing for calculating a distance between the first participant and the camera.

19. The method of claim 18, further comprising:
providing for adjusting a magnification level of the camera based on the distance between the first participant and the camera.

20. A machine-readable medium including program code that, when executed by a machine, causes a machine to perform a method of:
capturing a first video signal depicting a first participant to a video conference wearing an invisible light source, the first video signal having both visible and invisible components;
orienting a first field-of-view of a camera to center the invisible light source within the first field-of-view;
transmitting the visible component of the first video signal to a second participant to the video conference;
receiving a second video signal depicting a second participant; and
displaying the second video signal to the first participant.
